(19) United States
(12) Patent Application Publication
(10) Pub. No.: US 2018/0150609 A1
(43) Pub. Date: May 31, 2018

(54) SERVER AND METHOD FOR PREDICTING FUTURE HEALTH TRENDS THROUGH SIMILAR CASE CLUSTER BASED PREDICTION MODELS

(71) Applicant: Electronics and Telecommunications Research Institute, Daejeon (KR)

(72) Inventors: Minho KIM, Daejeon (KR); YoungWon KIM, Daejeon (KR); Donghun LEE, Daejeon (KR); Jae Hun CHOI, Daejeon (KR); Dae Hee KIM, Daejeon (KR); Myung-eun LIM, Daejeon (KR); Ho-Youl JUNG, Daejeon (KR); Youngwoong HAN, Daejeon (KR); Seunghwan KIM, Daejeon (KR)

(73) Assignee: Electronics and Telecommunications Research Institute, Daejeon (KR)

(21) Appl. No.: 15/812,540

(22) Filed: Nov. 14, 2017

(30) Foreign Application Priority Data
Nov. 29, 2016 (KR) 10-2016-0160713
Nov. 29, 2016 (KR) 10-2016-0160718
Nov. 29, 2016 (KR) 10-2016-0160721

(51) Int. Cl. G06F 19/00; G06N 99/00; G06N 5/04

(52) U.S. Cl. CPC G06F 19/345; G06N 99/005; G06F 19/322; G06F 19/3437; G06N 5/048

(57) ABSTRACT

The present disclosure herein relates to a future health trend forecasting system and a method thereof through a similar case cluster-based prediction model, and more specifically, to a server and a method thereof for extracting multiple associated feature similar case clusters that match a prediction query for the user's health information through a class prediction model and a future value prediction model for health features of a similar case cluster generated by cyclically clustering the target feature that is a health feature for personal health information and an associated feature of the target feature, predicting future health trends for each associated feature using multiple prediction models based on corresponding similar case clusters, and combining and outputting the prediction results.

### CROSS-REFERENCE TO RELATED APPLICATIONS

This U.S. non-provisional patent application claims priority under 35 U.S.C. § 119 of Korean Patent Application No. 10-2016-0160713, filed on Nov. 29, 2016, Korean Patent Application No. 10-2016-0160718, filed on Nov. 29, 2016, and Korean Patent Application No. 10-2016-0160721, filed on Nov. 29, 2016, the entire contents of which are hereby incorporated by reference.

### BACKGROUND

The present disclosure herein relates to a future health trend forecasting system and a method thereof through a similar case cluster-based prediction model, and more specifically, to a server and a method thereof for extracting multiple associated feature similar case clusters that match a prediction query for the user's health information through a class prediction model and a future value prediction model for health features of a similar case cluster generated by cyclically clustering the target feature that is a health feature for personal health information and an associated feature of the target feature, predicting future health trends for each associated feature using multiple prediction models based on corresponding similar case clusters, and combining and outputting the class prediction results.

With the recent medical advances and living standards improvement, human life expectancy is rapidly increasing, and modern society is turning into an aging society. On the other hand, new and diverse forms of disease are emerging due to global warming, increased risk factors for human health, and changes in lifestyle including eating habits.

Unlike the past that as the social environment is changed, the pattern of disease is changed greatly, in which infectious diseases mainly occurred, recently, the incidence of non-infectious diseases such as circulatory diseases, diabetes, cancer, cardiovascular and hypertension is rapidly increasing. Since most non-infectious diseases have a high burden on the cost of treatment, it is necessary to prevent and manage the health deterioration by predicting the future health trend of a user. Therefore, the importance of prevention and management to prevent health deterioration by predicting future health trends is greatly emphasized.

However, since a typical future health trending system searches for similar cases on the basis of all health characteristics (i.e., features) that appear in a user's personal health record, the number of cases is too large, the time required for the search is very long, the complexity of the system configuration is very high, and the features having low relevance to the user's disease are included in searching for similar cases, and therefore, the results of predicting the health status of the user on the basis of the retrieved similar cases have a problem that the accuracy thereof is so low that reliable prediction results may not be provided.

### SUMMARY

The present disclosure provides a future health trend forecasting system and a method thereof for predicting a similar case using a prediction model based on a similar case cluster for a prediction query for user's health information and outputting a prediction result.

The present disclosure also provides a future health trend forecasting system having excellent processing speed and accuracy and a method thereof for determining a similar case cluster for a prediction query for the health information of a user, searching for a class prediction model for the determined similar case cluster, and performing a similar case prediction for each of a plurality of class prediction models to output a plurality of class prediction results.

The present disclosure also provides a future health trend forecasting system having low complexity and high accuracy and a method thereof for performing an ensemble for a plurality of class prediction results to select and output at least one or more future value prediction models and performing a similar case prediction for at least one or more future value prediction models.

The present disclosure also provides a future health trend forecasting system capable of dramatically reducing the complexity of a configuration and a method thereof for generating a plurality of similar case clusters for a target feature through a hierarchical clustering technique when performing similar case clustering to predict future health trends for a specific target feature, and then, based on this, performing similar case clustering for generating similar case clusters for an associated feature associated with the target feature.

The present disclosure also provides a similar case clustering system and a method thereof for rapidly searching similar case clusters for user's target features and similar case clusters for associated features to predict user's future health trends, on the basis of the similar case cluster information on the similar case cluster for the target feature and the associated feature generated through the hierarchical clustering and the information on a set of optimum features for each target.

The present disclosure also provides a similar case clustering system and a method thereof for providing a reliable prediction result on the future health trend of a user by performing the clustering of target features for predicting the future health status of the user and performing the clustering of associated features associated with the target feature on the basis of the clusters of the performed target features to generate a prediction model for future health trend, and selecting a prediction model having a high (optimum) accuracy from the generated prediction models and performing an ensemble of at least one class prediction result outputted through the selected prediction model to provide learning input data of the prediction model for driving a final prediction result.

An embodiment of the inventive concept provides a server for predicting future health trends based on a similar case cluster. The server includes: a class prediction model selection unit configured to select a plurality of class prediction models from a prediction query for health information of a user; a class and future value prediction unit configured to perform a prediction for each of the plurality of class prediction models to output a plurality of class prediction results and perform a prediction on at least one future value prediction model to output a future value prediction result; and a future value prediction model selection unit configured to perform an ensemble of the plurality of class prediction results to select and output at least one future value prediction model.

In an embodiment, the class prediction model selection unit may include: a similar case cluster determination unit configured to determine a similar case cluster by receiving the prediction query; and a class prediction model searching unit configured to search for a class prediction model for the determined similar case cluster, wherein the similar case cluster may be generated by hierarchically clustering a target feature and an associated feature of the target feature from a plurality of time series health data, and may include personal health record data generated by grouping a plurality of patterns that change in time series for a predetermined time section and classes obtained by dividing a value range of a target feature appearing after a predetermined time section in the similar case cluster into a plurality of sections.

In an embodiment, the class prediction model may be a prediction model for the probability of a class in a similar case cluster for the associated feature, and the future value prediction model may be a future value prediction model that learned for each class of a similar case cluster for the associated feature or a future value prediction model learned including all classes of a similar case cluster for the associated feature.

In an embodiment, predicting the future health trends may be to predict a change in future health trends of a section following a change pattern for a specific section of time series health data.

In an embodiment, the similar case cluster determination unit may determine a corresponding similar case cluster by matching the prediction query to representative information on the similar case cluster, and the representative information may be information on a change pattern representing a plurality of time series personal health data in one similar case cluster.

In an embodiment, the similar case cluster determination unit may determine a corresponding similar case cluster by matching the prediction query to health feature of an associated feature cluster selected from the class prediction model of the similar case cluster, and the selected associated feature may be an associated feature extracted during a process for selecting an associated feature class prediction model that satisfies a criterion for a predetermined accuracy among all associated features.

In an embodiment, the class prediction model searching unit may search for a prediction model for a similar case cluster determined to be matched with the prediction query from a similar case prediction model database and load the prediction model.

In an embodiment of the inventive concept, a future health trend prediction method includes: a class prediction model selection operation for, by a server, receiving a prediction query for health information of a user from a user terminal to select a plurality of class prediction models; a class prediction operation for, by the server, predicting a plurality of class prediction results for the plurality of class prediction models; a future value prediction model selection operation for, by the server, performing an ensemble of the plurality of class prediction results to select at least one future value prediction model; and a future value prediction operation for, by the server, performing a prediction on the at least one future value prediction model and outputting a future value prediction result to the user terminal.

In an embodiment of the inventive concept, a future health trend prediction method through a similar case cluster-based prediction model includes: a prediction model filtering operation for, by a server, calculating an accuracy for a corresponding prediction model of an associated feature cluster matched with a prediction query of health information of a user received from a user terminal and filtering a prediction model satisfying a predetermined accuracy; a class and a future value prediction operation for, by the server, calculating a plurality of class prediction results for the plurality of filtered prediction models; and an operation for, by the server, performing an ensemble of the plurality of class prediction results to output the ensembled class prediction result to the user terminal.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a conceptual diagram for explaining a similar case clustering device for predicting future health trends according to an embodiment of the inventive concept;

FIG. 2 is a diagram for conceptually illustrating a process of generating a similar case cluster by performing clustering and using this to perform machine learning and generate a prediction model;

FIG. 3 is a conceptual diagram illustrating a process of generating a similar case cluster by performing clustering using a similar case clustering device for predicting future health trends and performing machine learning by using the similar case cluster to generate a prediction model according to an embodiment of the inventive concept;

FIG. 4 is a block diagram illustrating a configuration of a similar case clustering device according to an embodiment of the inventive concept;

FIG. 5A is a view illustrating personal health record stored in a personal health record database according to an embodiment of the inventive concept;

FIG. 5B is a view illustrating time-series personal health record data in a similar case clustering device for predicting future health trends according to an embodiment of the inventive concept;

FIG. 6 is a view illustrating result of performing a similar case clustering process for a target feature in a similar case clustering device for predicting future health trends according to an embodiment of the inventive concept;

FIG. 7 is a view illustrating result of performing a similar case clustering process for an associated feature in a similar case clustering device for predicting future health trends according to an embodiment of the inventive concept;

FIG. 8 is a view for explaining a process of learning a similar case cluster generated by a hierarchical clustering technique to generate a prediction model according to an embodiment of the inventive concept;

FIG. 9 is a flowchart illustrating a procedure for similar case clustering according to an embodiment of the inventive concept;

FIG. 10A is a view explaining the concept of a process of generating a future health trend prediction model according to an embodiment of the inventive concept;

FIG. 10B is a view explaining the concept of a prediction result according to an embodiment of the inventive concept;

FIG. 11 is a block diagram illustrating a configuration of a similar case cluster-based future health trend prediction model generation device according to an embodiment of the inventive concept;

FIG. 12 is view for explaining a process of selecting an optimal prediction model by testing a plurality of generated prediction models using a similar case cluster according to an embodiment of the inventive concept;

FIG. 13 is a view for explaining a process of testing a class prediction model for a plurality of associated feature clusters and performing an ensemble of a plurality of class prediction results to determine a final result according to an embodiment of an inventive concept;

FIG. 14 is a flowchart illustrating a process for generating a prediction model and selecting an optimal class prediction model according to an embodiment of the inventive concept;

FIG. 15 is a block diagram illustrating a configuration of a personal health trend prediction device according to an embodiment of the inventive concept;

FIG. 16 is a flowchart illustrating a procedure for a future health trend prediction process according to an embodiment of an inventive concept; and

FIG. 17 is a flowchart illustrating a procedure for a future health trend prediction process according to another embodiment of an inventive concept.

### DETAILED DESCRIPTION

Hereinafter, a similar case clustering device and method for predicting future health trends of the inventive concept will be described in detail with reference to the accompanying drawings. The inventive concept may, however, be embodied in different forms and should not be constructed as limited to the embodiments set forth herein. Like parts are designated with like reference numerals throughout the specification.

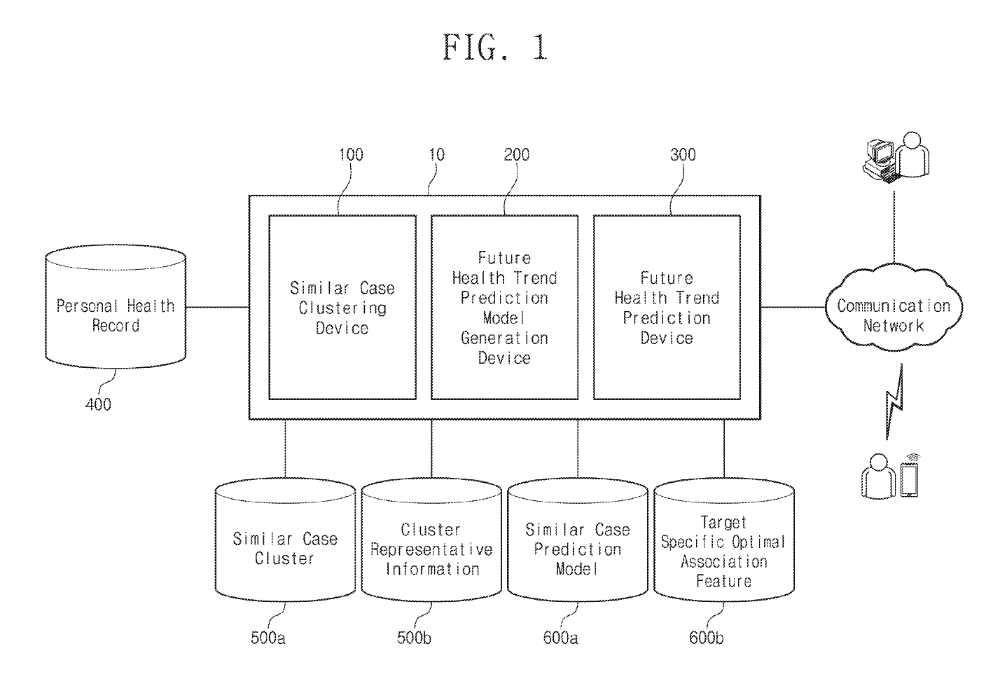

FIG. 1 is a conceptual diagram for explaining an entire future health trend prediction system according to an embodiment of the inventive concept. The future health trend forecasting system 10 includes a similar case clustering device 100, a future health trend prediction model generation device 200, and a future health trend prediction device 300.

As shown in FIG. 1, a similar case clustering device 100 for predicting a future health trend according to an embodiment of the inventive concept receives personal time-series health information from a personal health record database 400, and performs clustering for each similar case. The result of the clustering is stored in a similar case cluster database 500a, the set of representative information of the similar case cluster is stored in the cluster representative information database 500b, the similar case cluster is inputted to a future health trend prediction model generation device 200 to be used for generating a prediction model for predicting future health trends, the generated prediction model is stored in the similar case prediction model database 600a, and the prediction model is used to predict future health trends in the future health trend prediction device 300 together with the representative information of the similar case cluster. In addition, the future health trend prediction model generation device 200 tests the prediction performance of the class prediction model for the associated feature in the set of optimal associated features for each target with respect to the class prediction model, and stores the selected prediction model information in the target specific optimal associated feature database 600b. Such a process may be controlled by a user and an administrator through a communication network and also, the final prediction result may also be provided to a user terminal.

Moreover, the similar case clustering device 100 according to an embodiment of the inventive concept may be configured as a future health trend prediction system 10 together with a future health trend prediction model generation device 200 and a future health trend prediction device 300 or may be configured as a separate device and connected as one system through a communication network. In addition, the similar case clustering device 100, the future health trend prediction model generation device 200, and the future health trend prediction device 300 may be configured in one cloud server, or may be configured as a system that is implemented in each distributed server, integrated into one, and serviced.

For this, the similar case clustering device 100, the future health trend prediction model generation device 200, and the future health trend prediction device 300 may be implemented in a computer system such as a computer-readable recording medium. The similar case clustering device 100 may include a processor for performing similar case-based clustering, which will be described later. The future health trend prediction model generation device 200 may include a processor for generating a predictive model to be described later. The future health trend prediction device 300 may include a processor for predicting future health trends to be described later. Such a processor may be implemented as a dedicated circuit such as an application specific integrated circuit (ASIC), or may be implemented as software or firmware.

Hereinafter, the motivation for inventing a similar case clustering device for predicting future health trends and method thereof in the inventive concept will be described.

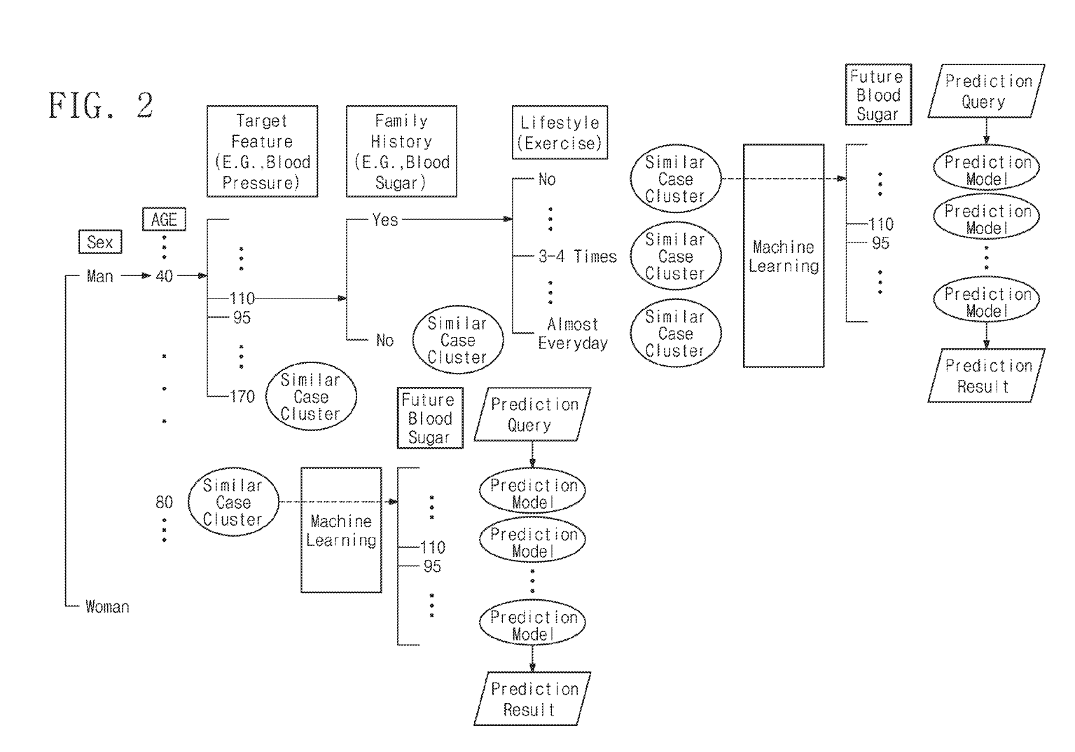

FIG. 2 is a diagram for conceptually illustrating a process of generating a similar case cluster and using this, performing machine learning to generate a prediction model.

As shown in FIG. 2, the similar case clustering is a structure for generating similar case clusters for features associated with all personal health information, and generating prediction models through machine learning for each cluster. In this case, for example, if a man is 40-year-old, has a blood sugar level of 110, has a family history of diabetes, and exercises little, since a similar case cluster generating method generates a prediction model for a plurality of future blood glucose levels, receives a prediction query for personal health from a user terminal, and outputs a prediction result, prediction models corresponding to the number of all cases should be generated in advance, so that there is an issue that the number of prediction models may be greatly increased.

That is, a prediction model is generated through machine learning for each similar case cluster, and a prediction query for personal health is inputted from a user terminal to output the prediction result. Therefore, the complexity is greatly increased and the accuracy is also lowered. For this reason, the generation of a prediction model in the generation of a similar case cluster according to the typical is required to handle all the health characteristics, so that the number of cases becomes too large.

Hereinafter, in order to handle such an issue, by generating a plurality of similar case clusters through hierarchical clustering that sequentially performs similar case clustering for a target feature and similar case clustering for associated features associated with the target feature on the basis of a plurality of time-series personal health record data, a clustering method that dramatically reduces the number of similar case clusters is to be described.

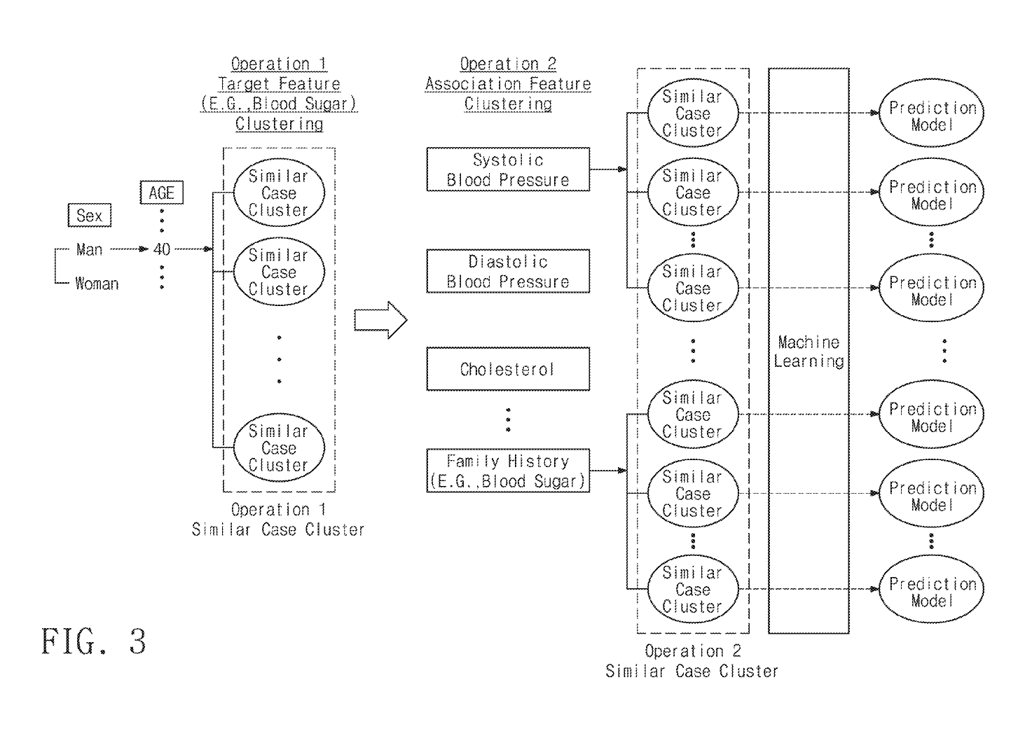

FIG. 3 is a conceptual diagram illustrating a process of generating a similar case cluster by performing clustering using a similar case clustering device for predicting future health trends and performing machine learning by using the similar case cluster to generate a prediction model according to an embodiment of the inventive concept.

First, the similar case clustering device 100 loads a plurality of personal health records stored in the personal health record database 400, and generates at least one prediction model for a target feature on the basis of the loaded plurality of personal health records.

Also, the similar case clustering device 100 performs hierarchical clustering of the plurality of personal health records loaded from the personal health record database 400 to generate a plurality of similar case clusters.

Here, the hierarchical clustering includes a similar case clustering for a target feature (operation 1) and a similar case clustering for an associated feature closely associated with the target feature (operation 2). On the other hand, the operation 2 similar case clustering may be performed not only for an associated feature closely associated with the target feature, but also for all the health features shown in the personal health record.

Also, the target feature means a health feature (e.g., blood sugar) that is a target of future health trend prediction among the health characteristics included in a plurality of personal health records, and the associated feature means a health characteristic associated with the target feature. For example, if the target feature is blood sugar, the associated feature may be systolic blood pressure, diastolic blood pressure, LDL cholesterol, family history (e.g., diabetes), and the like.

Hereinafter, a method of performing similar case clustering using the target feature as blood sugar will be described in detail. However, it is apparent that the inventive concept is not limited thereto and may be applied to other health characteristics for predicting future health values.

The personal health record database 400 may be also be implemented locally or on a network and may be a storage for storing individual personal health records such as public cohort information provided by the Health Insurance Review & Assessment Service or the National Health Insurance Corporation, or patient's personal health records provided by a medical institution such as a hospital, or personal health records provided by individual users. Furthermore, personal health records may also be grouped according to gender, age, etc. and stored in the personal health record database 400.

Also, first, the similar case clustering device 100 converts and normalizes the plurality of personal health records loaded from the personal health record database 400 into time-series personal health record data in order to efficiently perform learning for generating similar case clustering and prediction models.

The converted personal health record data is obtained by grouping and converting the respective time-series changing health characteristics on the basis of each personal health record, and may include a personal ID (or personal ID indicating each personal health record) and health characteristics (e.g., body weight, height, systolic blood pressure, diastolic blood pressure, age, etc.) for each predetermined time interval (e.g., year).

Also, the similar case clustering device 100 performs the operation 1 similar case clustering on the target feature on the basis of the personal health record data to generate a plurality of operation 1 similar case clusters (e.g., ten clusters) to provide a cluster for generating prediction models for predicting future health trends for a target feature.

Also, the similar case clustering device 100 performs the operation 2 clustering on the associated feature for each generated operation 1 similar case cluster, thereby generating a plurality of operation 2 similar case clusters.

Also, the similar case clustering device 100 performs the operation 2 clustering on the associated feature associated with the target feature on the basis of the personal health record data included in each of the generated operation 1 similar case clusters, thereby generating a plurality of operation 2 similar case clusters for each operation 1 similar case cluster.

That is, the operation 1 similar case clustering groups target features that change in a time-series for a predetermined time period according to patterns to generate a plurality of similar case clusters for the target feature, and the operation 2 similar case clustering generates a plurality of similar case clusters for each of the associated features associated with the target feature for each operation 1 similar case cluster for the target feature with the same mechanism as the operation 1 similar case clustering.

In the inventive concept, the hierarchical clustering for generating the similar case cluster is not limited to the operation 1 and operation 2 similar case clustering, and may generate a similar case cluster by performing similar case clustering in a plurality of operations, for example, performing the operation 1 clustering for a specific feature and the operation 2 clustering for an associated feature associated with the specific feature and also performing operation 3 clustering with another associated feature associated with the associated feature used for the operation 2 similar case clustering.

Also, the similar case clustering device 100 generates a similar case cluster for each associated feature generated through the hierarchical clustering method, stores the similar case cluster in the similar case cluster database 500a, and allows the future health trend prediction model generation device 200 to generate a cluster-specific prediction model for the target feature.

Further, the future health trend prediction model generation device 200 tests each of the generated prediction models to select a prediction model having an accuracy higher than a preset numerical value or having an accuracy higher than a preset order, there by selecting the optimal associated feature for the feature and storing the selected prediction model in the similar case prediction model database 600a.

In addition, the future health trend prediction device 300 includes personal health records from a user terminal, and when receiving a prediction query for a specific target feature, determines which of the similar case clusters for the target feature generated through the hierarchical clustering is similar to the user's target feature, and then, determines which similar case cluster among the similar case clusters of the selected optimal associated feature is similar to the user's target feature.

Further, the future health trend prediction device 300 searches and loads a multiple prediction model for the target feature generated on the basis of the optimal associated feature stored in the similar case prediction model database 600a according to the determined similar case cluster. And, the future health trend prediction device 300 performs an ensemble of class prediction results outputted for each model using the loaded multiple prediction model to provide a final prediction result to a user terminal.

Accordingly, the similar case clustering device 100 according to the inventive concept does not search for similar cases for all health characteristics appearing in the personal health record, and first, searches for the similar cases only for the optimal health characteristics that are associated with the specific health characteristics among the similar cases for the found specific health characteristics so that the number of cases for the search can be drastically reduced, and this greatly reduces the complexity of the configuration of the future health trend forecasting system 10.

In addition, since it predicts the future health trend for the target feature by using the optimal associated feature closely associated with the target feature, rather than predicting the future health trend on the basis of all the health characteristics shown in the personal health record, the time required for prediction may be shortened, and a clustering method for providing a reliable prediction result with high accuracy may be provided.

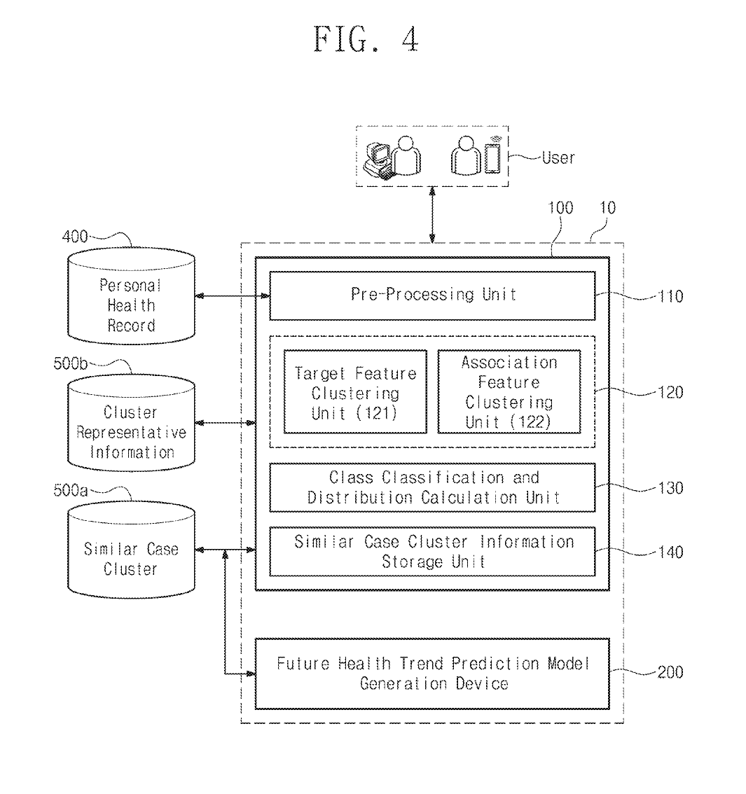

FIG. 4 is a block diagram illustrating a configuration of a similar case clustering device 100 according to an embodiment of the inventive concept.

As shown in FIG. 4, the similar case clustering device 100 includes a pre-processing unit 110 for converting a plurality of personal health records stored in the personal health record database 400 into time-series personal health record data, a similar case cluster generation unit 120 for performing hierarchical clustering from the pre-processed personal health record data to generate a similar case cluster, and a class classification and distribution calculation unit 130 for classifying the generated cluster and calculating a probability distribution of a corresponding class. Representative information of the similar case cluster and the similar case cluster generated by the similar case cluster generation unit 120 is stored in the similar case cluster database 500a and the cluster representative information database 500b, respectively. In addition, the class classification and distribution calculation unit 130 calculates the class distribution, and the similar case cluster information storage unit 140 stores representative information of the generated similar case cluster and similar case cluster in the similar case cluster database 500a and the cluster representative information database 500b, respectively. Herein, the similar case cluster includes learning input data and class labels.

Herein, the pre-processing unit 110 loads a plurality of personal health records stored in the personal health record database 400 and converts them into personal time-series personal health record data.

Also, the converted personal health record data is converted to efficiently generate the similar case cluster and perform the learning of the prediction model, and includes each health characteristic according to a predetermined time period for each personal ID.

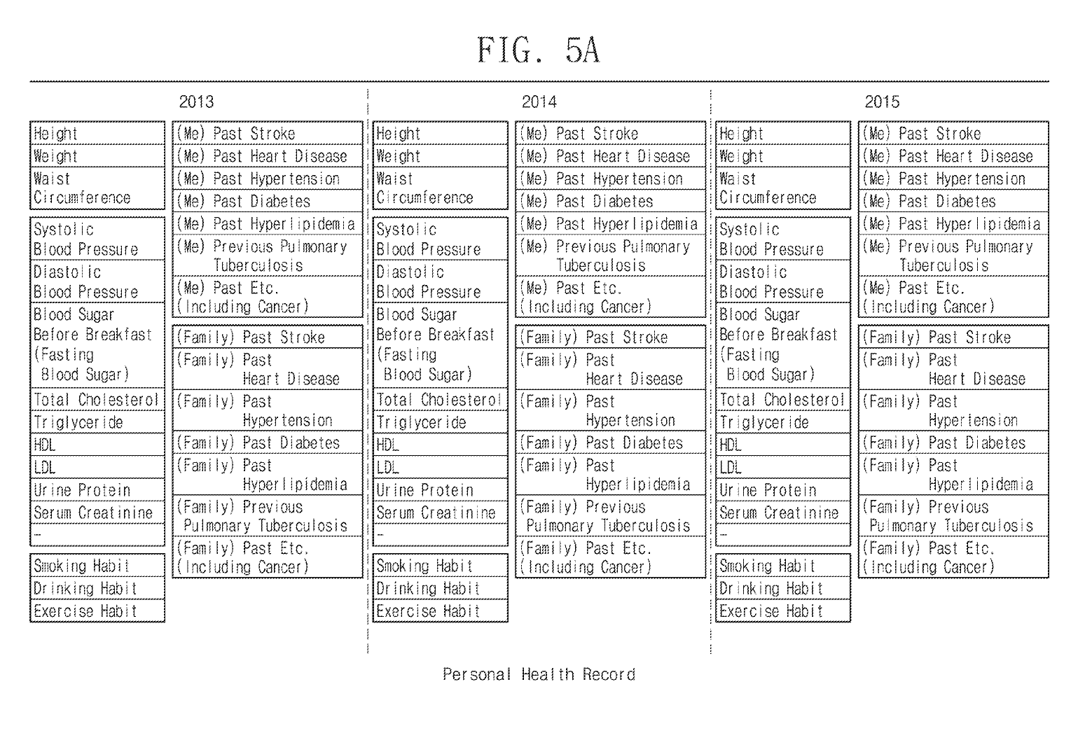

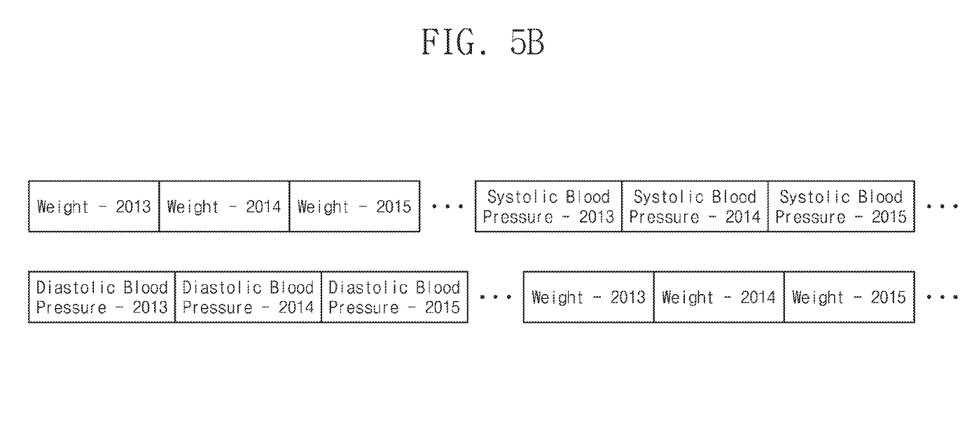

FIG. 5A is a view illustrating personal health record stored in a personal health record database according to an embodiment of the inventive concept. FIG. 5B is a view illustrating time-series personal health record data in a similar case clustering device for predicting future health trends according to an embodiment of the inventive concept. As shown in FIG. 5A, a plurality of personal health records may be stored in the personal health record database 400 as unique values representing each health information, and loaded in a pre-processing unit according to the inventive concept. As shown in FIG. 5B, the plurality of personal health records may be converted into individual time-series personal health record data.

Also, the pre-processing unit 110 normalizes each converted personal health record data to have a value between 0 and 1. In addition, health characteristics that do not appear as specific numerical values, for example, smoking or not, drinking or not, may be normalized to 0 or 1.

In addition, the pre-processing unit 110 also selects data available for prediction model learning from the converted personal health record data. It is selected to learn health characteristics that change over a predetermined period and predict trends in health characteristics after the predetermined period. For example, since learning data used to predict the fourth year blood sugar level by learning the changing pattern for a blood sugar level over three years requires a blood sugar level measured over four consecutive years, personal health record data that includes measurement values for four consecutive years (i.e., 4 consecutive years of examination) is selected.

On the other hand, the pre-processing unit 110 may check whether or not the data is missing from the selected personal health record data. If there is missing data according to a check result, the missing data may be interpolated by calculating the median value or the average value. For example, if blood sugar levels in 2013, 2015, and 2016 are 80 mg/dl, 90 mg/dl, and 95 mg/dl, respectively, and blood sugar levels in 2014 are missing, on the basis of the blood sugar levels in 2013 and 2015, which are before and after 2014, the median or average value may be calculated to interpolate the blood sugar level in 2015 to 85 mg/dl.

Also, the similar case cluster generation unit 120 includes a target feature clustering unit 121 for generating a plurality of similar case clusters from the personal health record data through the hierarchical clustering technique and performing similar case clustering on the target feature to generate a similar case cluster for the target feature and an associated feature clustering unit 122 for performing similar case clustering on the basis of the personal health record data included in each similar case cluster for the target feature to generate a similar case cluster for the associated feature. Such clustering may be performed by cyclically performing hierarchical clustering including target features and associated features a plurality of times.

In addition, the target feature clustering unit 121 may also group patterns for a plurality of target features that change in a time-series for a predetermined time period (e.g., 3 years, 5 years, 10 years, etc.) on the basis of personal health record data in order to generate a plurality of operation 1 similar case clusters.

For example, if the target feature is blood sugar, the target feature clustering unit 121 groups a plurality of target features with a similar pattern on the basis of a pattern for the time-series changing blood sugar levels measured over three years, and generates representative (pattern) information for each of the grouped target features. When a query for predicting future health trends is inputted from a user, this representative pattern is used to identify a similar case cluster for the health characteristics of a user, thereby forming one similar case cluster, and represents a plurality of personal health data included in the case cluster.

That is, if the target feature is blood sugar, a plurality of target features (i.e., blood sugar) representing a similar pattern, for example, the pattern of changes in blood sugar levels that change over three years is maintained at a constant numerical value within a specific range (e.g., normal range, risk range, or randomly set range), increasing changes to decreasing, a normal range changes to a risk change, or a critical range changes to a normal range, is grouped into one group to generate a plurality of similar case clusters for the target feature. Also, the representative pattern is also expressed in a pattern that changes in a time-series for a predetermined period. The representative pattern represents a pattern for each of a plurality of grouped target features and is generated by calculating a representative value for a target feature appearing in a plurality of personal health data included in a corresponding similar case cluster. The representative value may be set to an intermediate value or an average value for a plurality of target features.

In addition, the associated feature clustering unit 122 performs the operation 2 similar case clustering for at least one associated feature to generate a plurality of operation 2 similar case clusters on the basis of the personal health record data included in each of the plurality of operation 1 similar case clusters generated by performing the operation 1 similar case clustering on the target feature.

The operation 2 similar case clustering, which is performed for each operation 1 similar case cluster generated by completing the operation 1 similar case clustering, is performed with the same mechanism as the operation 1 similar case clustering.

In addition, the class classification and distribution calculation unit 130 classifies the classes of the associated features included in the cluster for each clustered target feature, calculates a class distribution, and stores the class distribution in the similar case cluster representative information database 500b. Herein, on the basis of the stored probability distribution, the future probabilistic prediction model generation device 200 generates a class probability prediction model through machine learning and stores it in the prediction model database 600a.

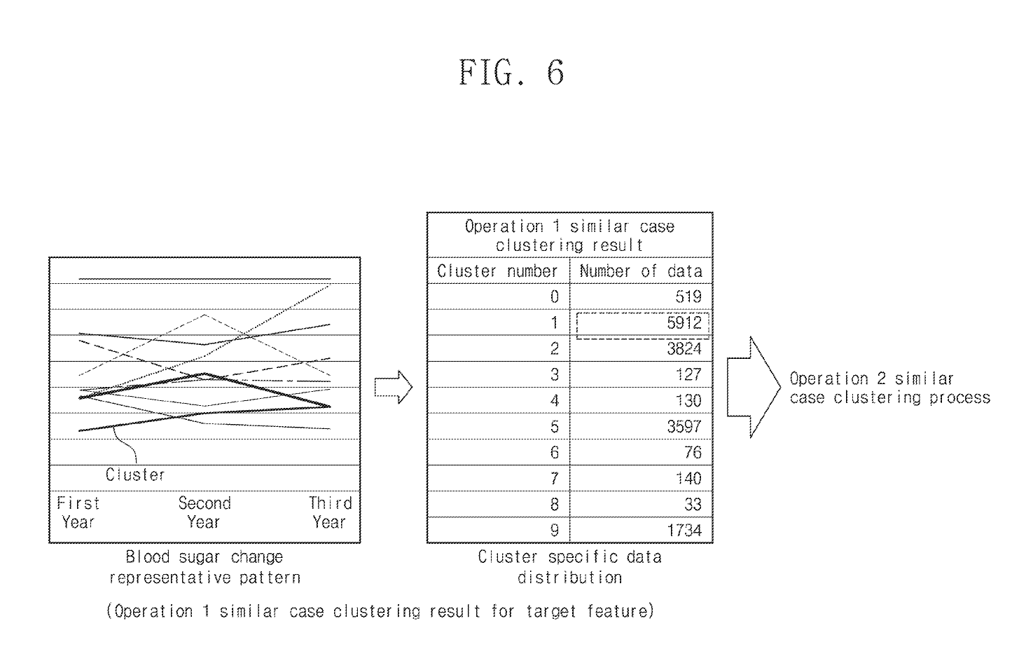

On the other hand, as shown in FIGS. 6 to 8, each similar case cluster generated through the operation 1 similar case clustering and the operation 2 similar case clustering includes personal health record data for the target feature or the associated feature generated by grouping a plurality of patterns that are changed in a time-series for a predetermined time period and a class in which a target feature appearing after a predetermined time period included in the similar case cluster is divided into a plurality of sections. The process of generating a plurality of similar case clusters generated through the hierarchical clustering technique will be described in detail with reference to FIGS. 6 to 8.

FIG. 6 is a view illustrating a result of performing an operation 1 similar case clustering process for a target feature according to an exemplary embodiment of the inventive concept.

As shown in FIG. 6, the process of performing the operation 1 similar case clustering on the target feature (e.g., blood glucose) is first to load a plurality of personal health records from the personal health record database 400 through the pre-processing unit 110 provided in the similar case clustering device 100.

Also, the plurality of loaded personal health records are pre-processed through the pre-processing unit 110 to be converted into time-series personal health record data as shown in FIGS. 5A and 5B and then, through the target feature clustering unit 121 configured in the similar case clustering device 100, the operation 1 similar case clustering for each target feature appearing in the converted personal health record data is performed. That is, the plurality of operation 1 similar case clusters for a target feature are generated for each pattern by grouping according to a time-series changing pattern of the target feature for a predetermined time period.

In addition, the results of the operation 1 similar case clustering include a cluster number for identifying each of a plurality of operation 1 similar case clusters and a distribution of personal health record data included in each operation 1 similar case cluster.

Then, the similar case clustering device 100 performs an operation 2 similar case clustering for an associated feature for each operation 1 similar case cluster on the basis of the corresponding operation 1 similar case cluster.

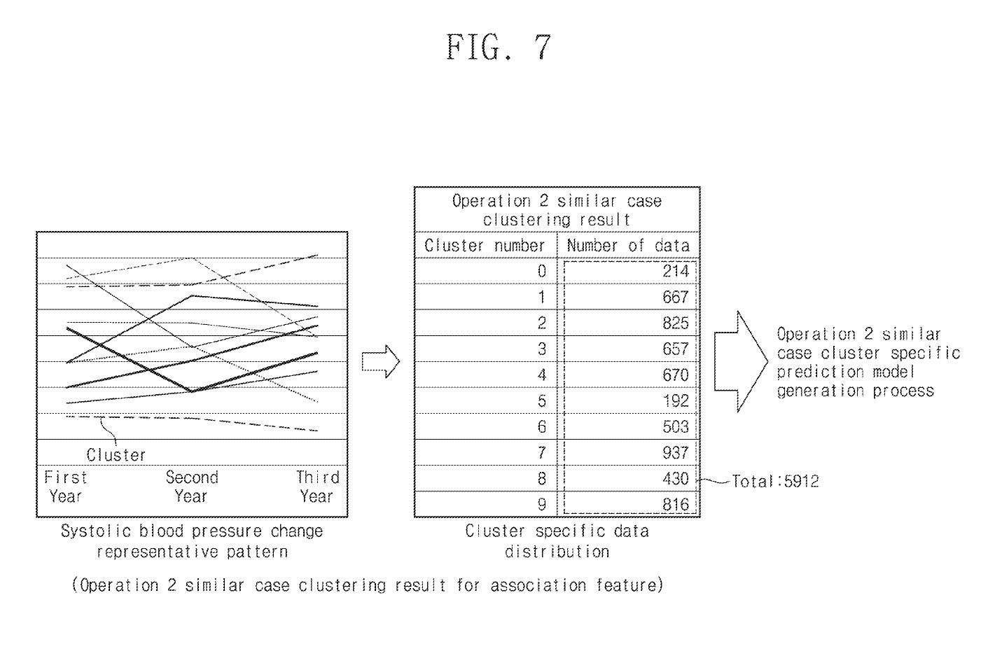

Hereinafter, the operation 2 similar case clustering process will be described in detail with reference to FIG. 7. The similar case clustering device and the method according to the inventive concept include hierarchically clustering time-series personal health record data through at least two operations to generate a similar case cluster, and the generated similar case cluster is labeled by each class and inputted as learning data of prediction models for predicting future health trends.

FIG. 7 is a view illustrating a process of performing an operation 2 similar case clustering for an associated feature according to an embodiment of the inventive concept.

As shown in FIG. 7, the process of performing the two-step similar case clustering on the associated feature (e.g., systolic blood pressure) performs stage similar case clustering for each of the operation 1 similar case clusters generated by the target feature clustering unit 121 through the associated feature clustering unit 122 provided in the similar case clustering device 100. The clustering performs clustering on target features first, and then performs clustering on associated features for each similar case cluster for the target features to perform similar case clustering. Detailed clustering of the target features and the associated features is performed through unsupervised machine learning including one of hierarchical clustering, bayesian clustering, and partition clustering. The inventive concept is not limited to clustering techniques relating to the unsupervised machine learning described herein.

That is, the associated feature clustering unit 122 divides each of the operation 1 similar case clusters into a plurality of operation 2 similar case clusters for each associated feature associated with the target feature, and performs the operation 2 similar clustering on the associated feature on the basis of the linear or nonlinear distribution of data included on the operation 2 similar case cluster for each associated feature.

Also, the operation 2 similar case clustering performed by the associated feature clustering unit 122 is performed with the same mechanism as the target feature clustering unit 121.

Accordingly, the results of the operation 2 similar case clustering, which is generated for the associated feature, include a cluster number for identifying each of the plurality of operation 2 similar case clusters and a distribution of personal health record data included in each operation 2 similar case cluster.

Also, the operation 1 similar case clustering and the operation 2 similar case clustering are performed sequentially through the target feature clustering unit 121 and the associated feature clustering unit 122.

As described above, the operation 2 similar case clustering for the associated feature is performed on the basis of the operation 1 similar case cluster for the target feature.

For example, when performing the operation 2 similar case clustering for the number 1 cluster among the plurality of operation 1 similar case clusters shown in FIG. 6, by using the number of data (total 5912) included in the number 1 cluster, the operation 2 similar clustering is performed. That is, as a result of performing a plurality of operation 2 similar case clustering using the total 5912 of data, the total number of data included in a plurality of operation 2 similar case clusters is 5912.

Also, each of the generated similar case clusters includes personal health record data obtained by grouping a plurality of patterns that change in a time series for a predetermined time period and classes in which target features appearing after a predetermined time period included in the similar case cluster are divided by a plurality of sections.

Further, the class, which means a range for a numerical value that changes after a predetermined time period of a corresponding similar case cluster (i.e., a change value for blood sugar in a prediction section), represents, for example, when each similar case cluster is grouped and generate by a time-series changing pattern for 3 years through the target class clustering unit 121 and the associated feature clustering unit 122, a section (e.g., when the target feature is blood sugar, a range for the blood sugar level is divided into a plurality of sections) for the fourth target feature.

Then, the future health trend prediction model generation device 200 generates a prediction model for predicting a change in blood sugar level through a prediction model generation process using a plurality of operation 2 similar case clusters for the generated associated feature.

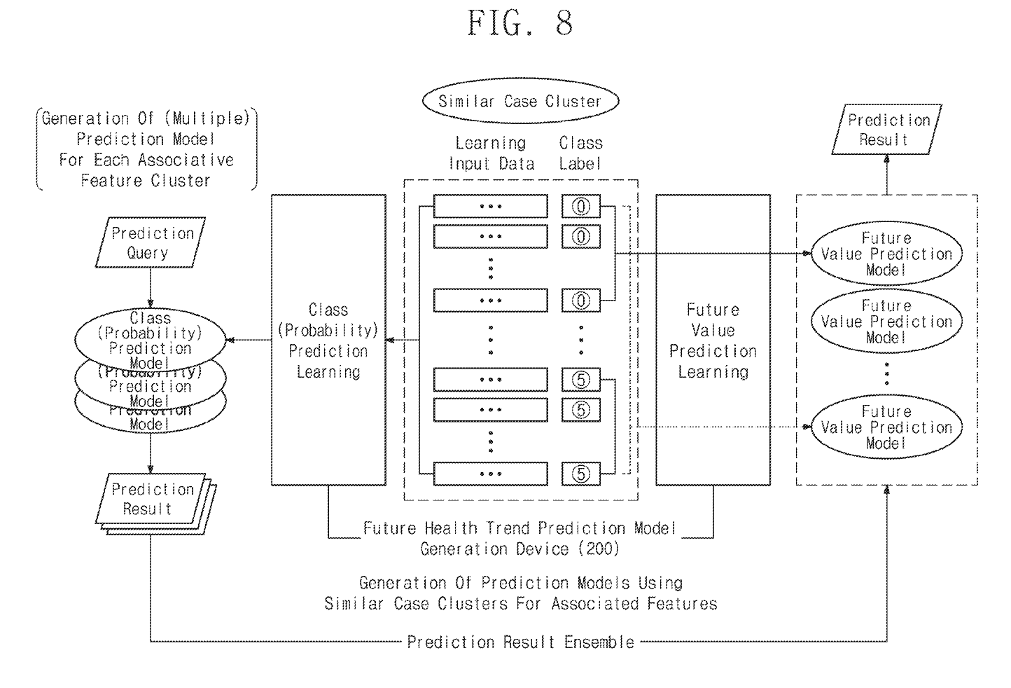

Hereinafter, a process of generating a prediction model for predicting a future change of a target feature using an operation 2 similar case cluster for an associated feature will be described in detail with reference to FIG. 8. That is, the similar case clustering device 100 according to the inventive concept performs clustering by first extracting a time-series changing pattern of a specific section for a target feature from time-series health data, and then performs clustering by extracting a time-series changing pattern corresponding to a specific section with respect to an associated feature for each cluster of the target feature. The prediction of the future health trend is to predict a pattern for future health trends of a section following the time-series changing pattern of the specific section.

FIG. 8 is a view for explaining a process of learning a similar case cluster generated by a hierarchical clustering technique to generate a prediction model, and using it to predict a future health trend according to an embodiment of the inventive concept.

As shown in FIG. 8, the similar case clustering device 100 according to the inventive concept classifies similar case clusters, which are generated through similar case clustering, by each class, calculates a distribution of associated features in each target feature cluster to generate a class prediction model for the corresponding distribution, and generates a similar case cluster and stores it in the similar case cluster database 500a in order to classify the similar case clusters of the associated feature by each class and generate a future value prediction model by using it as learning input data, thereby, by using the future value prediction model, allowing the future prediction model generation unit 200 to generate class prediction models and future prediction models.

Herein, in the case of the future value prediction learning, the future value prediction model may be generated for each class, but one future value prediction model may be generated by inputting the entire learning data.

On the other hand, the learning input data learned to generate the prediction model, which is personal health record data for an associated feature that changes in a time series with respect to a predetermined time section included in a similar case cluster, includes the characteristics (e.g., a value for systolic blood pressure) of the associated feature appearing after a predetermined time section and the characteristics (e.g., a value for blood sugar) of the target feature for the corresponding associated feature. For example, the learning data inputted to predict a numerical value of blood sugar at the fourth year is a consecutive four-year blood sugar numerical value (e.g., a target feature) and a consecutive four-year systolic blood pressure (e.g., an associated feature).

Meanwhile, the future health trend prediction device 300 predicts the future health trend of a corresponding user on the basis of the selected optimal associated feature and prediction model when there is a query about future health trend from a user. That is, a cluster specific prediction model and a future value prediction model of each class are generated, and the learning input data of the prediction model for ensemble of class prediction results by each production model generated by a prediction device for predicting future health trends is provided. Therefore, the similar case clustering device 100 according to the inventive concept performs the hierarchical clustering to generate a multiple prediction model where the number of similar case clusters is reduced, thereby reducing the complexity of predicting future health trends and performs an ensemble of a plurality of class prediction results when predicting future health trends for a specific query of health information using the generated multiple prediction model, thereby improving the accuracy of the final prediction for the specific query.

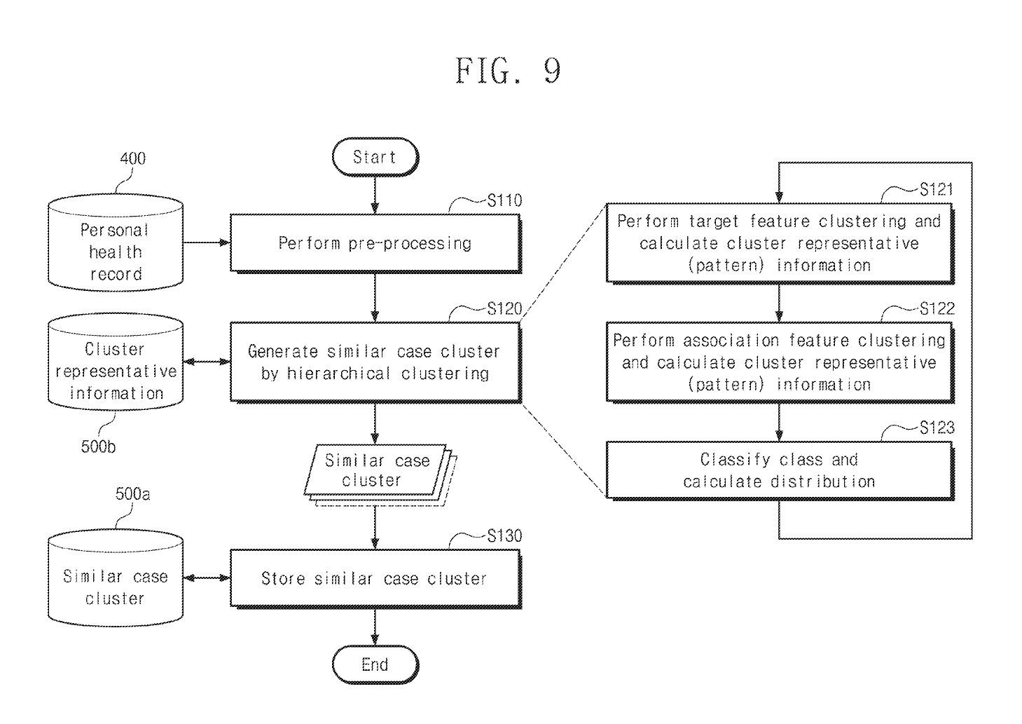

FIG. 9 is a flowchart illustrating a procedure for similar case clustering according to an embodiment of the inventive concept.

First, the similar case clustering device 100 receives personal health records from the personal health database 400 and performs pre-processing (S110). The pre-processing includes converting data of the inputted personal health records into a format suitable for use in the similar case clustering device 100, and performing a process of normalizing each feature. Herein, the conversion includes converting various information such as text, numbers, images, or voice to be suitable for clustering according to the type of data.

The normalization is to converge the dynamic range of input data to a value between 0 and 1, thereby simplifying and unifying the handling of data. However, the scope of such normalization is not limited.

The pre-processed personal health records generate a similar case cluster by hierarchical clustering (S120). Since the generated similar case clusters have various hierarchical structures, they are stored in the similar case cluster database 500a while maintaining the characteristics of the hierarchical structure (S130).

For example, if the target feature is blood sugar, the target feature clustering unit 121 groups a plurality of target features with a similar pattern on the basis of a pattern for the time-series changing blood sugar levels measured over three years, and generates representative (pattern) information for each of the grouped target features. When a query for predicting future health trends is inputted from a user, this representative pattern is used to identify a similar case cluster for the health characteristics of a user, thereby forming one similar case cluster, and represents a plurality of personal health data included in the case cluster.

Here, the similar case cluster generation process (S120) by hierarchical clustering first performs target feature clustering and generates representative information for each target feature. Such representative information, which is used to identify a similar case cluster for a health characteristic of a user when a query for prediction of future health trends is inputted from the user, forms one similar case cluster and becomes information of a pattern representing a plurality of personal health data included in one similar case cluster (S121). Then, associated feature clustering is performed for the personal health records included in each target feature cluster, and representative information of the cluster is also calculated for the performed associated feature cluster (S122). Next, each cluster generated through the associated feature clustering is classified by each class and a distribution of personal health record data for a corresponding class is calculated (S123).

The generated similar case cluster representative information is stored in the similar case cluster representative information database 500b and the similar case cluster is stored in the similar case cluster database 500a.

Accordingly, the similar case clustering device 100 according to the inventive concept performs clustering on the target features of the time-series personal health record data to generate a plurality of target feature clusters, extracts a distribution for the time-series personal health record data for each of the generated target feature clusters, performs clustering on associated features of the time-series personal health record data included in each of the generated target feature clusters to generate a plurality of associated feature clusters, extracts a distribution for the time-series personal health record data for each of the generated associated feature clusters, hierarchically performs clustering on the target feature and the association at least one time in a manner that the associated feature becomes the target feature of the next clustering, and finally generates a class probability prediction model that predicts the probability of each class distribution and a future value prediction model for each class with respect to the plurality of extracted associated feature clusters.

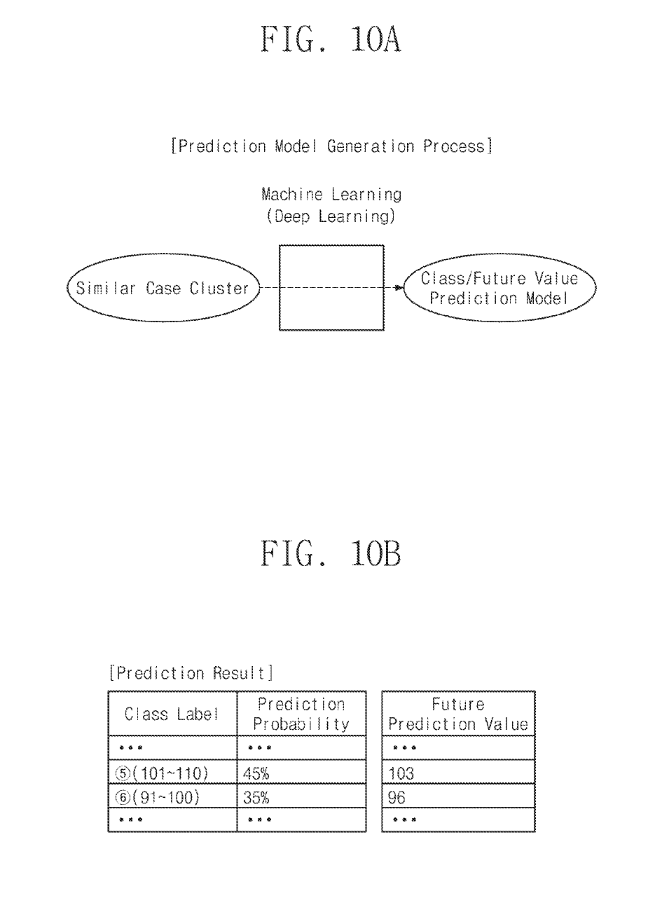

FIG. 10A is a view explaining the concept of a process of generating a future health trend prediction model according to an embodiment of the inventive concept. FIG. 10B is a view explaining the concept of a prediction result according to an embodiment of the inventive concept.

As shown in FIG. 10A, the generation process of the similar case cluster-based future health trend prediction model generates a class prediction model for the probability of each class included in the similar cluster by receiving a similar case cluster and generates a future value prediction model for each class of the similar case cluster or for the entire similar case class. At this time, the generation of the prediction model is performed through machine learning such as deep learning.

As shown in FIG. 10B, each of the similar case clusters finally clustered for the similar case cluster generated as the result of the hierarchical clustering has a plurality of class labels, and a prediction probability of how each class having the same label is distributed in the similar case cluster is derived, thereby creating a class prediction model. In addition, if machine learning is performed using each similar case cluster as learning data, a prediction model for predicting a future value is generated.

As shown in FIG. 10B, the class label is a label given using the distribution of each data in the corresponding similar case cluster, and the class prediction probability is calculated according to the number of data belonging to the corresponding label. In addition to the prediction model for such a prediction probability, a future value prediction model is generated for one similar case cluster or each class in a similar case cluster, and a future value is predicted by deriving a prediction value using the prediction model.

Next, a similar case cluster-based future health trend prediction model generation device according to an embodiment of the inventive concept will be described.

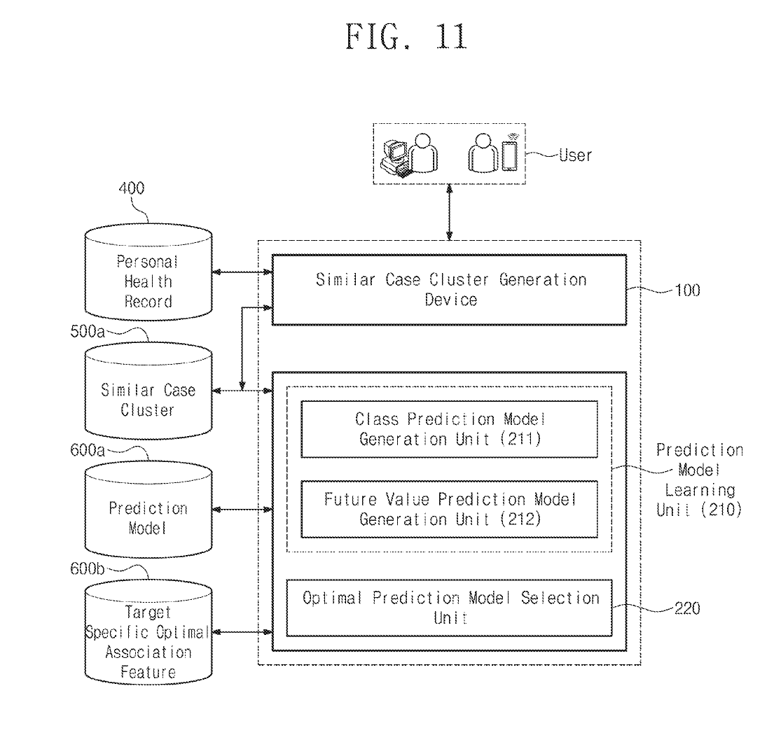

FIG. 11 is a block diagram illustrating a configuration of a similar case cluster-based future health trend prediction model generation device according to an embodiment of the inventive concept.

As shown in FIG. 11, the similar case cluster-based future health trend prediction model generation device 200 includes a prediction model learning unit 210 and an optimal prediction model selection unit 220. First, in relation to the future health trend prediction model generation device 200, the similar case clustering device 100 loads personal health records from the personal health record database 400 to read the similar case clusters of the similar case cluster database 500a, which are generated and stored through hierarchical clustering, the prediction model learning unit 210 generates a class prediction model and a future prediction model, and the optimal prediction model selection unit 220 selects a prediction model having a certain accuracy or more from the class prediction models and stores it in the prediction model database 600a. Also, the future prediction model is immediately stored in the prediction model database 600a. In addition, the optimal prediction model selection unit 220 selects the optimal associated feature for each target through a class probability distribution, and stores it in the target specific optimal associated feature database 600b.

Hereinafter, each configuration of the future health trend prediction model generation device 200 will be described in detail.

First, the prediction model learning unit 210 learns an operation 2 similar case cluster for each associated feature for a similar case cluster for each specific target feature generated through the hierarchical clustering technique, and generates a plurality of prediction models for each operation 2 similar case cluster. Also, each of the similar case clusters for each associated feature for each similar case cluster of the target feature is learned, and a plurality of prediction models for predicting the future health trend of the target feature are generated for each similar case cluster for each associated feature.

In addition, the prediction model learning unit 210 includes a class (probability) prediction model generation unit 211 for learning a similar case cluster for each associated feature associated with the target feature to predict the probability for each class and a future value prediction model generation unit 212 for predicting a future value for each class.

In addition, the class prediction model generation unit 211 learns similar case clusters for each associated feature for the similar case cluster of a target feature, and generates a class prediction model for predicting the probability for the future value class of a target feature for each class based on the linear or nonlinear distribution of the data for each class. The class prediction model may predict the probability of each class based on a machine learning algorithm such as Deep Belief Network (DBN) or Convolutional Neural Network (CNN).

In addition, the class prediction model predicts the probability of each class based on the linear or nonlinear distribution of the total data included in the corresponding similar case clusters.

For example, if the target feature is a blood sugar and the associated feature is a systolic blood pressure, the class prediction model generator 211 generates a class prediction model by learning the operation 2 similar case cluster for systolic blood pressure for each operation 1 similar case cluster for blood sugar. Also, the generated class prediction model predicts the probability of the future value class of the target feature for each class based on the linear or nonlinear distribution of class-specific data for blood sugars appearing after a predetermined period based on the learned operation 2 similar case cluster. That is, based on a similar case cluster with four-year blood sugar numerical values and systolic blood pressure numerical values, the pattern according to three-year numerical value changes is learned and numerical values (i.e., fourth-year numerical values) for blood sugar appearing after three years are predicted with the probability of each section (that is, by each class).

Also, the future value prediction model generation unit 212 learns the operation 2 similar case cluster for each associated feature generated for each similar case cluster of the target feature, and generates a future value prediction model for predicting a future value for each class.

The future value prediction model may predict the future value with respect to the target of the learning input data of each class or all similar case clusters based on a machine learning algorithm such as Recurrent Neural Network (RNN).

Meanwhile, DBN, CNN and RNN applicable in the prediction model learning unit 210 are machine learning algorithms mainly used for data analysis and prediction.

However, the inventive concept is not limited to DBN, CNN, and RNN. Based on learned similar case clusters, various machine learning algorithms may be applied to predict the probability for each future value class of the target feature or predict future values.

Also, the future value prediction model generation unit 212 learns similar case clusters for each associated feature to generate a future value prediction model for predicting a future value for the target feature for each class, and the future value prediction model predicts future values for the target features appearing after a predetermined time section for a plurality of target features included in each class.

In addition, the optimal prediction model selection unit 220 tests the class prediction model generated through the prediction model learning unit 210 to select a class prediction model having an accuracy equal to or higher than a predetermined numerical value or an accuracy equal to or higher than a predetermined ranking.

Through this, the optimal prediction model selection unit 220 selects an optimal associated feature for a specific target feature, thereby determining a similar case cluster for a corresponding target feature when a prediction query for a specific target feature is inputted from a user, and then, determines a similar case cluster only for the selected optimal associated feature, thereby predicting the future value for the target feature quickly and accurately.

The test is performed for each of a plurality of candidate probability prediction models generated by learning clusters for each associated feature associated with the target feature. Through this, it is possible to select a class prediction model having a high accuracy and select an optimal associated feature closely associated with a specific target feature at the same time.

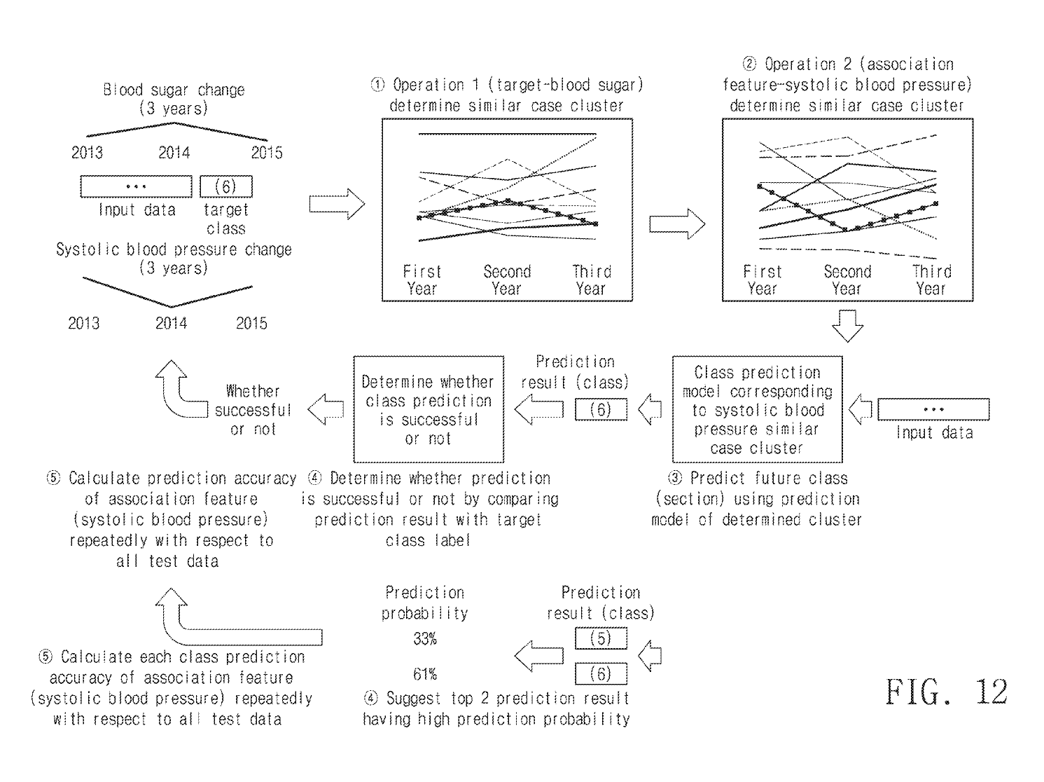

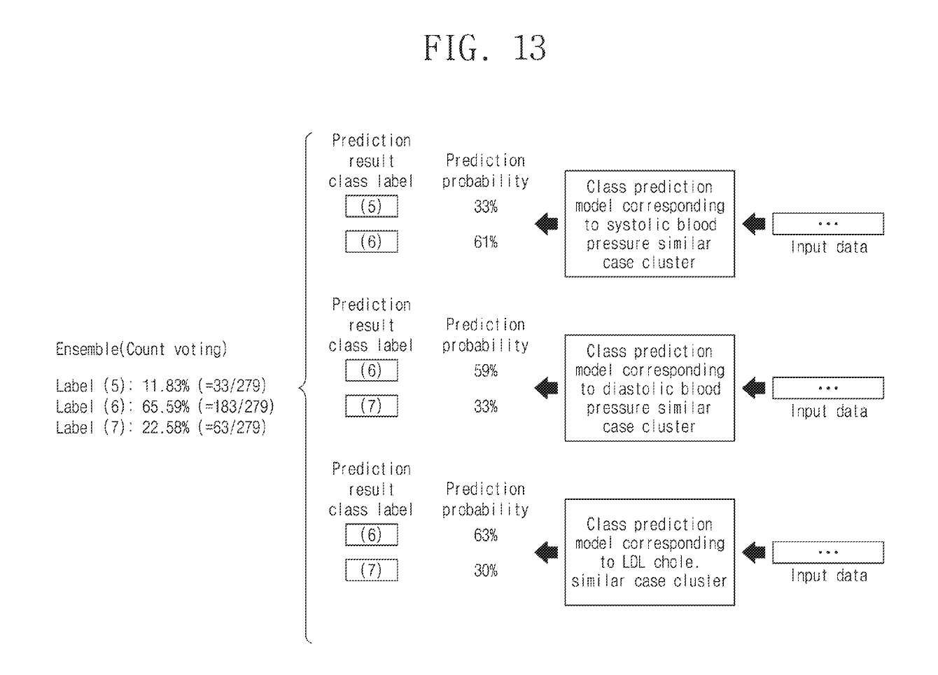

Meanwhile, a test for selecting an optimal class prediction model will be described in detail with reference to FIG. 12 and FIG. 13. The optimal prediction model selection unit 220 stores information on an optimal prediction model and an optimal associated feature for the selected target feature in the prediction model database 600a so as to be used by the future health trend prediction device 300.

FIG. 12 is view for explaining a process of selecting an optimal prediction model by testing a plurality of prediction models generated using an operation 2 similar case cluster according to an embodiment of the inventive concept.

As shown in FIG. 12, a process of selecting an optimal prediction model by testing a plurality of prediction models generated using the operation 2 similar case cluster first selects an optimal prediction model among a plurality of prediction models for each associated feature generated using as an input the personal health record data used for learning in the optical prediction model selection unit 220 in the future health trend prediction model generation device 200.

The optimal prediction model selection unit 220 determines a change pattern (e.g., a three-year blood sugar change) \textcircled{1} for the target feature of the test input data and a change pattern (e.g., a three-year systolic blood pressure change) \textcircled{2} of the associated feature associated with the corresponding target feature.

Next, the class prediction model for the determined similar case cluster is loaded from the prediction model database 600a, the input data used for the test is inputted to the loaded class prediction model, and the class for the corresponding input data is predicted \textcircled{3}.

Next, the predicted class prediction result is compared with the target class of the input data to determine whether the prediction is successful \textcircled{4}. In addition, it is possible to calculate the prediction probability of the prediction result for each class and to present the top few class prediction results with high prediction probability \textcircled{4}.

The determining whether the prediction is successful or the presenting of the top few class prediction results may calculate the prediction accuracy by repeatedly performing all the test data to determine the class prediction result for each associated feature.

By applying such a process repeatedly to all the test data, the prediction accuracy of the associated feature may be calculated.

The test for each prediction model described with reference to FIG. 12 may calculate the accuracy of the corresponding prediction model finally by inputting the class prediction model to the n class learning models using one test group not participating in learning to check whether or not the class prediction of the prediction model is successful and calculate the accuracy thereof. The accuracy may select a predetermined number of top prediction models or a prediction model having a maximum or intermediate value of successful times by repeatedly applying all test input data to a specific prediction mode and then averaging the cases of successful predictions. It is also possible to calculate the prediction probabilities for each class and to present top few class prediction results.

The above process is performed for each of the operation 2 similar case clusters for all associated features and selects the optimal prediction model by calculating the accuracy of the prediction model for all operation 2 similar case clusters.

The selection is performed by selecting at least one prediction model having an accuracy of a predetermined numerical value or more, or an accuracy of a predetermined ranking or more.

FIG. 13 is a view for explaining a process of testing a class prediction model for a plurality of associated feature clusters and performing an ensemble of a plurality of class prediction results to determine a final result according to an embodiment of an inventive concept.

As shown in FIG. 13, a class prediction model is applied to a plurality of associated feature clusters to perform count voting and probability voting of the prediction probability top 2 on the output class prediction result, thereby extracting prediction probabilities on the top class labels. That is, the number of classes of 5 is one, and it has a prediction probability of 11.83% (33/279), three classes of 6, and a prediction probability of 65.59% (183/279). In addition, the number of levels of 7 is 2, and it has a prediction probability of 22.58% (63/279).

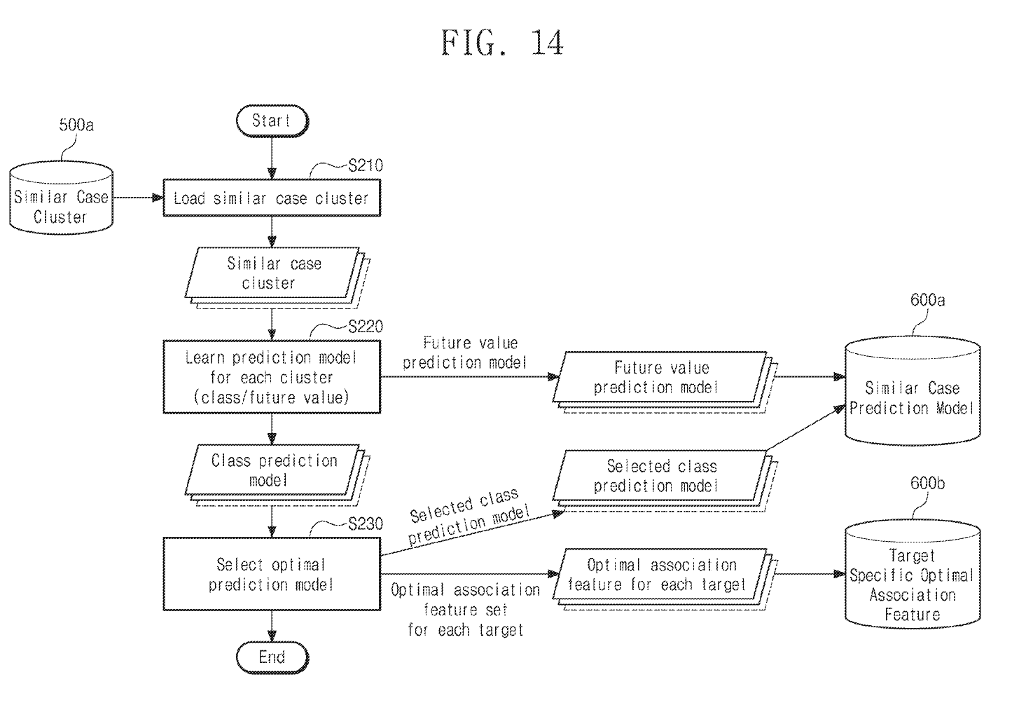

FIG. 14 is a flowchart illustrating a prediction model generation process and an optimal class prediction model selection process according to an embodiment of the inventive concept.

As shown in FIG. 14, the prediction model generation process first loads a plurality of personal health records stored in the health record database 400 through the similar case clustering device 100, generates a similar case cluster through a hierarchical clustering technique, and loads and fetches the similar case clusters stored in the similar case cluster database 500a from the future health trend prediction model generation device 200 (S210).

Next, a similar case cluster-specific prediction model learning (S220) is performed to generate a prediction model for each similar case cluster. The similar case cluster-specific prediction model learning is performed for a plurality of similar case clusters generated for each associated feature for a similar case cluster of a specific target feature.

Operation S220 described above is to generate a prediction model by learning a similar case cluster for the associated feature in a similar case cluster for a target feature and a similar case cluster for an associated feature associated with the target feature.

For example, if the target feature is blood sugar, a similar case cluster for blood sugar is generated, and if the associated feature for the blood sugar is systolic blood pressure, diastolic blood pressure, and cholesterol, similar case clusters for systolic blood pressure, diastolic blood pressure, and cholesterol are generated for each similar case cluster for blood sugar, and then a plurality of similar case clusters generated for each of the respective systolic blood pressure, diastolic blood pressure, and cholesterol are learned to generate a predict model for the blood sugar.

Similar case clusters for associated features are classified by each class. Herein, the class prediction model is divided into a class prediction model for predicting the probability of each class in the cluster and a future value prediction model for predicting future values for each class of a cluster or the entire clusters.

Therefore, a future value the prediction model is generated first for each similar case cluster or for each class in a similar case cluster and stored in the similar case prediction model database 600a.

However, instead of storing all the class prediction models in the similar case prediction model database with respect to a class prediction model, the optimal prediction models are selected from among a plurality of class prediction models and stored (S230). The selection may be performed by testing a plurality of prediction models for each of the generated associated features to calculate the accuracy of each prediction model and then, selecting a plurality of prediction models having an accuracy of a predetermined numerical value or more or an accuracy of a predetermined ranking or more.

Meanwhile, the test is performed for all class prediction models generated by learning clusters for each associated feature, and calculates the accuracy of all the class prediction models using data used for learning. Through this, it selects an optimal associated feature closely associated with future changes of a specific target feature by selecting a class prediction model of a high accuracy.

For example, if the target feature is blood sugar and the associated feature for blood sugar is systolic blood pressure and LDL cholesterol, the future health prediction model generation device 200 determines a similar case cluster for blood sugar of test data and then determines a similar case cluster for all associated features (i.e., systolic blood pressure and LDL cholesterol), respectively. Thereafter, the predictive probability model for the determined systolic blood pressure and LDL cholesterol is loaded from the prediction model database 600a, and the prediction results of the class prediction model and the actual values of the test data are compared by inputting the plurality of test data, thereby calculating the accuracy of the loaded class prediction model.

That is, it is possible to compare the class prediction result with the class of the inputted test data to determine the prediction success or to select the top several classes having a high prediction probability, and this mechanism is performed for all test groups to calculate the accuracy of the class prediction model for the corresponding systolic blood pressure and LDL cholesterol. This is performed for candidate probability prediction models generated for similar case clusters for each associated feature, and the optimal class prediction model is selected through this.

In addition, since the class prediction model is generated for each associated feature, it has the same effect that determining the class prediction model having a high accuracy through the above-mentioned series of processes selects an associated feature closely associated with a future change of a specific target feature.

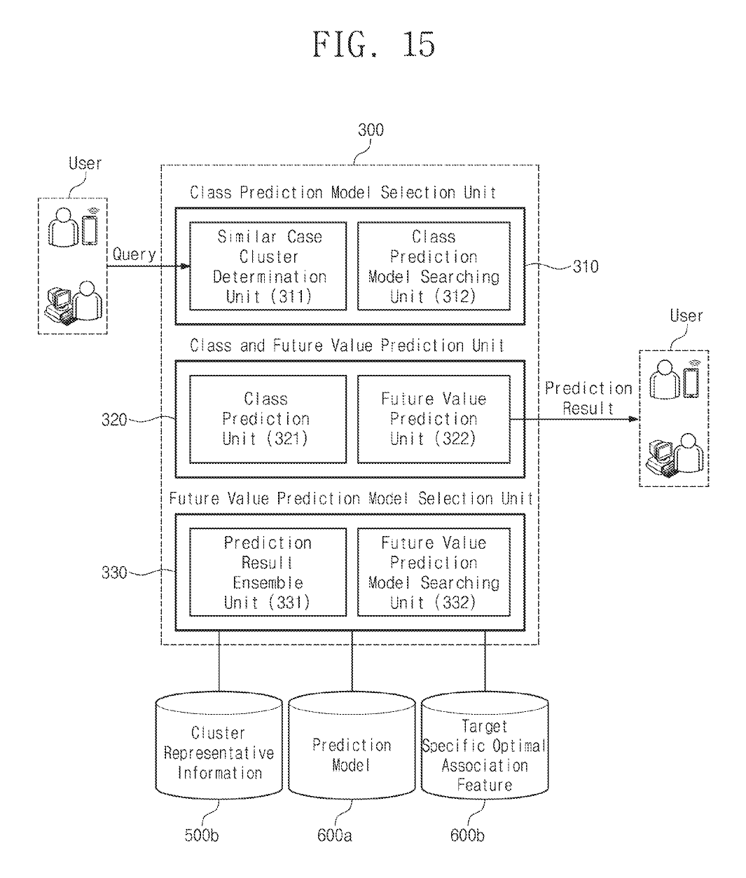

FIG. 15 is a block diagram illustrating a configuration of a future health trend prediction device according to an embodiment of the inventive concept.

As shown in FIG. 15, the future health trend prediction device 300 includes a class prediction model selection unit 310 for selecting a plurality of class prediction models from a prediction query of the user's health information, a class and a future value prediction unit 320 for performing a similar case prediction for each of a plurality of class prediction models, outputting a plurality of class prediction results, and performing a similar case prediction for at least one or more future value prediction models to output a future value prediction result, and a future value prediction model selection unit 330 for performing an ensemble of the plurality of class prediction results to select and output at least one or more future prediction models.

In addition, the class prediction model selection unit 310 includes a similar case cluster determination unit 311 for receiving a prediction query for health information of a user and determining a similar case cluster, and a class prediction model searching unit 312 for searching for a class prediction model for the determined similar case cluster. Herein, the similar case cluster is generated by hierarchically clustering a target feature and an associated feature of the target feature from a plurality of time series health data. Personal health record data generated by grouping a plurality of patterns that change in a time series for a predetermined time section and target features appearing after a predetermined time section included in the similar case cluster are classified into a plurality of classes.

In addition, the future health trend prediction device 300 receives a user query and a personal health record from a user through a user interface (not shown) included in a user terminal, and performs a preprocess it to generate and normalize time series personal health record data. This is performed in the same manner as the preprocessing process performed in the similar case clustering device 100.

That is, the preprocessing process loads a plurality of personal health records stored in the personal health record database 400 and converts them into personal-specific time series health record data. The converted personal health record data is transformed to efficiently generate a similar case cluster and learning of a prediction model and includes each health characteristic according to a predetermined time section. The personal-specific time series health record data described above is shown in FIG. 5B. Each of the converted personal health record data is normalized to have a value between 0 and 1. In addition, health features that do not appear as specific numerical values, for example, smoking or not, drinking or not, may be normalized to 0 or 1.

Like the personal health record of a specific individual shown in FIG. 5A, a plurality of personal health records may be stored in the personal health record database 400 as unique values representing each health information, loaded in a pre-processing unit according to the inventive concept, and converted into individual time-series personal health record data as shown in FIG. 5B.

The similar case cluster determination unit 311 loads a similar case cluster for a specific target feature according to a query of a user and a similar case cluster for each associated feature for each similar case cluster for the target feature. Moreover, a similar case cluster for each of the similar feature clusters for the target feature is a similar case cluster for the optimal associated feature for a specific target feature selected by the future health trend prediction model generation device 200.

Also, the similar case cluster determination unit 311 analyzes the pattern of the target feature indicated in the preprocessed personal health record data of a user to determine the operation 1 similar case cluster for the loaded target feature. The pattern of the target feature indicated in the preprocessed personal health record data of the user is analyzed to determine a similar case cluster for each of the loaded associated features. On the other hand, it is apparent that the personal health record data included in the similar case cluster for each of the determined associated features is a set of personal health record data included in the selected similar case cluster.

In addition, the class prediction model searching unit 312 searches and loads a prediction model database 500a storing a class prediction model generated by learning a similar case cluster for each of the determined associated features. The loaded class prediction model is an optimal multiple prediction model selected by the future health trend prediction model generation device 200.

Furthermore, the class and future value prediction unit 320 includes a class prediction unit 321 for performing a similar case prediction for each of a plurality of class prediction models to output a plurality of class prediction results and a future value prediction unit 322 for performing a similar case prediction for at least one or more future value prediction models to output a future value prediction result.

Specifically, the class prediction unit 321 predicts the probability of each class for the corresponding target feature through the loaded class prediction model, and outputs the prediction result for each class. The class prediction model is a prediction model for a class probability in a similar case cluster for the associated feature, and the future value prediction model is a future value prediction model learned for each class of the similar case cluster for the associated feature or a future value prediction model learned by including all classes of the similar case cluster for the associated feature.

In addition, predicting the future health trend also predicts a change in the future health trend of a section following a change pattern for a specific section of time series health data.

Also, the future value prediction model selection unit 330 includes a prediction result ensemble unit 331 and a future value prediction model searching unit 332.

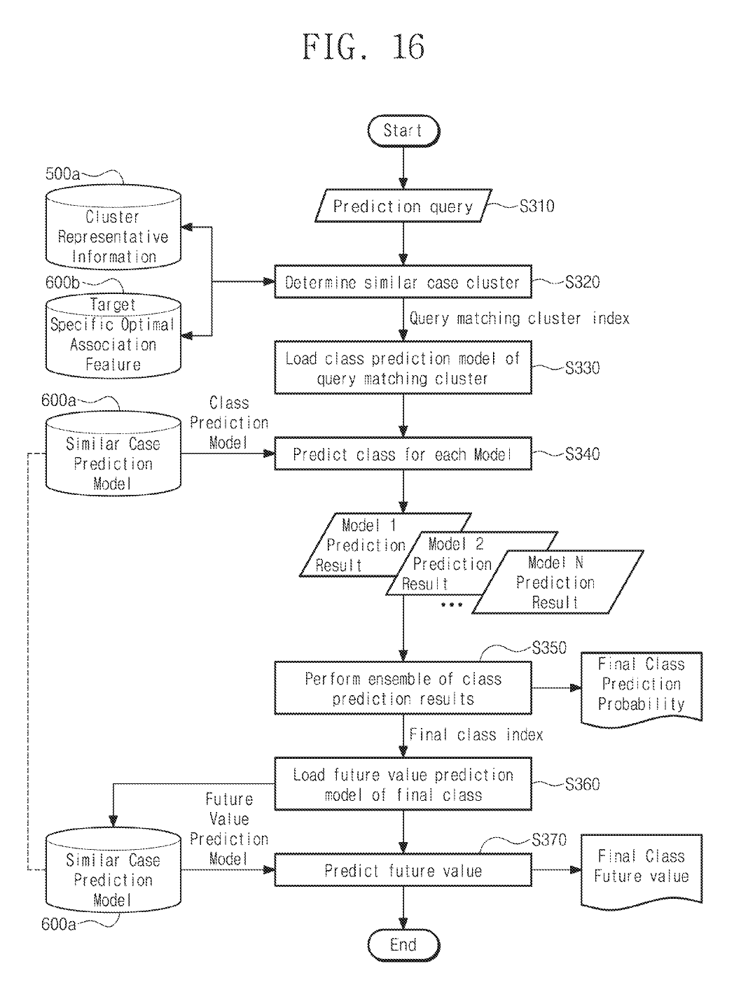

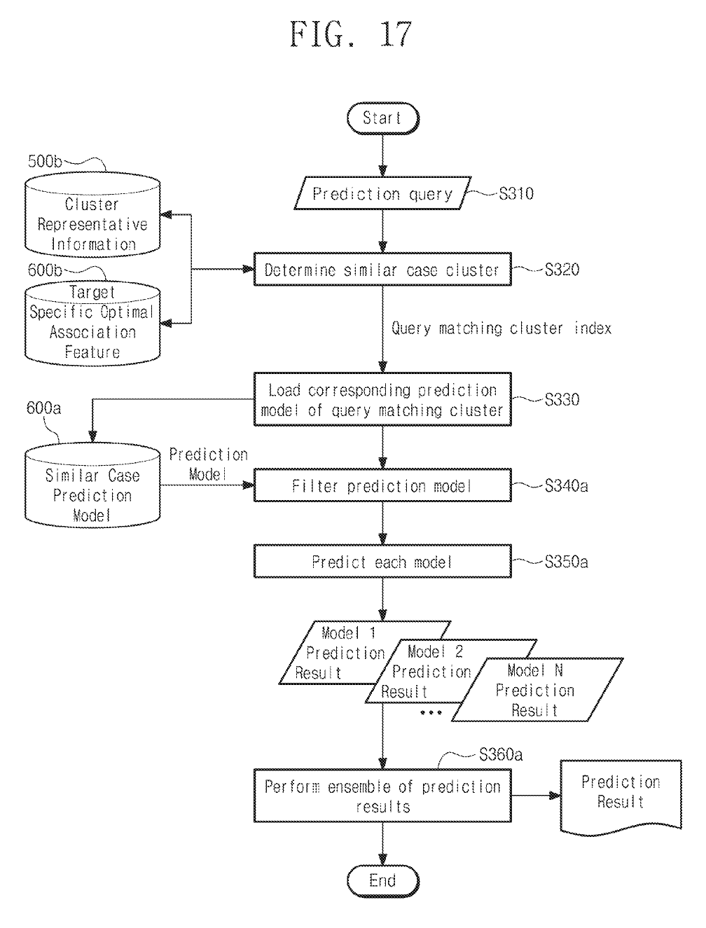

FIG. 16 is a flowchart illustrating a procedure for a future health trend prediction process according to an embodiment of an inventive concept.

As shown in FIG. 16, in relation to the procedure for predicting the future health trend by the future health trend predicting device 300, first, when a future health trend prediction query for a specific target feature is inputted from a user terminal together with the personal health record (S310), the future health trend prediction device 300 determines a corresponding similar case cluster through matching with a prediction query of a user based on representative information (e.g., pattern information) of a similar case cluster and information on an optimal associated feature set for each target (S320). That is, in order to efficiently perform the future health trend for a target feature, as in the process for performing clustering, the future health trend prediction device 300 converts the inputted personal health record into the time series personal health record data and normalizes the converted personal health record data to determine each similar case cluster. The determination includes a process for analyzing a pattern for a predetermined period for a target feature and a plurality of associated features from personal health record data, determining a similar case cluster for the most similar specific associated feature among similar case clusters for previously stored specific target features, and then determining similar case clusters for each associated feature through the same mechanism. On the other hand, the associated feature for the target feature means the optimal associated feature selected by the future health prediction model generation device 200.

Next, the future health trend prediction device 300 searches for and loads the multiple class prediction model for the optimal associated feature cluster from the similar case prediction model database 600a using the query matching cluster index according to a similar case cluster determined to match the prediction query (S330).

The multiple class prediction model for each similar case cluster for the associated feature loaded through the search is the optimal class prediction model selected through accuracy calculation. For example, if the target feature is blood sugar and the optimal associated feature for blood sugar selected by the future health trend prediction model generation device 200 is systolic blood pressure, diastolic blood pressure, and LDL cholesterol, the future health trend prediction device 300 determines a similar case cluster for blood sugar from the user's personal health record data, and the determination of the similar case cluster for the associated feature of the determined similar case clusters is performed only for systolic blood pressure, diastolic blood pressure, and LDL cholesterol. Thereafter, the optimal class prediction model generated by learning the similar case clusters for the determined systolic blood pressure, diastolic blood pressure, and LDL cholesterol is loaded. That is, when determining the optimal class prediction model by calculating the accuracy of the class prediction model, at least one class prediction model may be determined, and accordingly, a class prediction model for at least one or more optimal associated features for a specific target may be selected.

Next, the future health trend prediction device 300 performs a class prediction for each model using the searched and loaded multiple class prediction model (S340). The result of the class prediction for each model is a prediction result of the probability for each class.

Then, the future health trend prediction device 200 performs ensemble of the predicted class prediction results for each model, and finally extracts a class prediction probability for the target feature of the corresponding user and outputs an index of the final class (S350).

Next, the future health trend prediction device 300 loads a future value prediction model of the final class using the index of the final class (S360). Then, the future value prediction model is extracted from the similar case prediction model database 600a to perform future value prediction, and the future value of the final class is outputted to the user terminal (S370).

Herein, the future health trend prediction device 300 may predict the final health trend by averaging or calculating the intermediate value based on the prediction result for each model. That is, the future health trend prediction device 300 performs an ensemble of a plurality of class prediction results that predict a probability value for each class of the optimal associated feature through a class prediction model to determine a final prediction class, and predicts a future value for a corresponding class using a future value prediction model for the determined class to output the final prediction result for the user's query. On the other hand, as described above, the final prediction class may be determined to be at least one or more.

On the other hand, even when a plurality of optimal associated features are selected, a class prediction model for the plurality of selected optimal associated features is loaded and a final prediction class for each of the loaded class prediction models is determined so that the respective future values for the corresponding classes are expected using the future value prediction model for the plurality of determined final prediction classes. Thereafter, the future health trend prediction device 300 may provide the plurality of predicted future values to a user terminal, or may average the plurality of predicted future values or calculating them as an intermediate value and provide it to a user terminal.

Hereinafter, the future health trend prediction process according to another embodiment of the inventive concept will be described.

FIG. 17 is a flowchart illustrating a procedure for a future health trend prediction process according to another embodiment of an inventive concept.

As shown in FIG. 17, the process of receiving a future health trend prediction query for a specific target feature from a user terminal together with a personal health record from a user and loading a corresponding prediction model of a similar case cluster matching the prediction query is performed in the same manner as before. Of course, it is not necessary to match and load the class prediction model for the user's prediction query. A prediction model may be directly loaded without distinction of the class prediction model or the future value prediction model by receiving a user's prediction query from a user terminal (S310 to S330).

First, a process of reducing the number of models to be predicted by filtering the loaded prediction models is required (S340a). The filtering may utilize the distribution of target features and associated features calculated in a similar case clustering process, the distribution of classes, and the prediction probability value between the respective associated features.

Then, prediction for each prediction model is performed using the filtered prediction model (S350a). Since it is possible that the filtered prediction model (e.g., a prediction model having the best probability value or a prediction model corresponding to a plurality of top several ones) is plural, a class prediction result generated herein becomes plural.

Next, an ensemble of the generated class prediction results for each of a plurality of models is performed to output the class prediction results to the user terminal (S360a).

As described above, the future health trend prediction device 300 extracts at least one prediction model through filtering for a plurality of similar case prediction models without distinction of a class and a future value, and performs the ensemble of the extracted class prediction results for the extracted at least one prediction model to predict the final future value, thereby outputting the final prediction result for the user's query.

As described above, a future health trend forecasting system and a method thereof through a similar case cluster-based prediction model according to the inventive concept perform hierarchical clustering on the basis of a plurality of personal health record data to generate a similar case cluster according to the association between individual features and predict the future health trend of the user through the prediction model that learns the generated similar case cluster, so that it is possible to remarkably reduce the complexity of the system configuration and provide a quick and reliable prediction result to the user.

As described above, a server and a method thereof for predicting future health trends through a similar case cluster-based prediction model according to the inventive concept generate a class prediction model and a future value prediction model for the health feature of the similar case cluster generated by cyclically clustering a target feature and an associated feature of the target feature based on a plurality of personal health record data, select a plurality of class prediction models with high accuracy among the generated class prediction models, extract a class prediction result for a specific future health trend prediction query using a class prediction model among the multiple prediction models from a prediction query for the user's health information and perform an ensemble of the extracted class prediction results in a state where the future value prediction model is stored together, combines the extracted class prediction results, extract the final class prediction probability, and predict future health trends of the corresponding query using the future value prediction model for the corresponding class, so that the configuration of the future health trend forecasting system may be simplified, and quick and reliable prediction results may be provided to a user terminal.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A server for predicting future health trends based on a similar case cluster, the server comprising:
a class prediction model selection unit configured to select a plurality of class prediction models from a prediction query for health information of a user;
a class and future value prediction unit configured to perform a prediction for each of the plurality of class prediction models to output a plurality of class prediction results and perform a prediction on at least one future value prediction model to output a future value prediction result; and
a future value prediction model selection unit configured to perform an ensemble of the plurality of class prediction results to select and output at least one future value prediction model.

2. The server of claim 1, wherein the class prediction model selection unit comprises:
a similar case cluster determination unit configured to determine a similar case cluster by receiving the prediction query; and
a class prediction model searching unit configured to search for a class prediction model for the determined similar case cluster,
wherein the similar case cluster is generated by hierarchically clustering a target feature and an associated feature of the target feature from a plurality of time series health data, and comprises personal health record data generated by grouping a plurality of patterns that change in time series for a predetermined time section and classes obtained by dividing a value range of a target feature appearing after a predetermined time section in the similar case cluster into a plurality of sections.

3. The server of claim 2, wherein
the class prediction model is a prediction model for the probability of a class in a similar case cluster for the associated feature, and
the future value prediction model is a future value prediction model that learned for each class of a similar case cluster for the associated feature or a future value prediction model learned for all classes of a similar case cluster for the associated feature.

4. The server of claim 1, wherein predicting the future health trends is to predict a change in future health trends of a section following a change pattern for a specific section of time series health data.

5. The server of claim 2, wherein the similar case cluster determination unit determines a corresponding similar case cluster by matching the prediction query to representative information on the similar case cluster, and the representative information is information on a change pattern representing a plurality of time series personal health data in one similar case cluster.

6. The server of claim 5, wherein the similar case cluster determination unit determines a corresponding similar case cluster by matching the prediction query to health feature of an associated feature cluster selected from the class prediction model of the similar case cluster, and
the selected associated feature is an associated feature extracted during a process for selecting an associated feature class prediction model that satisfies a criterion for a predetermined accuracy among all associated features.

7. The server of claim 6, wherein the class prediction model searching unit searches for a prediction model for a similar case cluster determined to be matched with the prediction query from a similar case prediction model database and load the prediction model.

8. A future health trend prediction method comprising:
selecting a plurality of class prediction models, by a server, based on a prediction query for health information of a user received from a user terminal;
predicting a plurality of class prediction results, by the server, for the plurality of class prediction models;
performing an ensemble of the plurality of class prediction results, by the server, to select at least one future value prediction model; and
predicting a future value prediction result, by the server, based on the at least one future value prediction model to output the future value prediction result to the user terminal.

9. The method of claim 8, wherein selecting a plurality of class prediction models comprises:
receiving the prediction query, by the server, to determine a similar case cluster; and
searching for a class prediction model, by the server, searching for a class prediction model for the determined similar case cluster,
wherein the similar case cluster is generated by hierarchically clustering a target feature and an associated feature of the target feature from a plurality of time series health data, and comprises personal health record data generated by grouping a plurality of patterns that change in time series for a predetermined time section and classes obtained by dividing a value range of a target feature appearing after a predetermined time section in the similar case cluster into a plurality of sections.

10. The method of claim 9, wherein the class prediction model is a prediction model for the probability of a class in a similar case cluster for the associated feature, and
the future value prediction model is a future value prediction model that learned for each class of a similar case cluster for the associated feature or a future value prediction model learned for all classes of a similar case cluster for the associated feature.

11. The method of claim 8, wherein predicting the future health trends is to predict a change in future health trends of a section following a change pattern for a specific section of time series health data.

12. The method of claim 9, wherein receiving the prediction query, by the server, to determine a similar case cluster comprises matching the prediction query to representative information on the similar case cluster stored in a representative information database to determine a corresponding similar case cluster,
wherein the representative information is information on a change pattern representing a plurality of time series personal health data in one similar case cluster.

13. The method of claim 12, wherein receiving the prediction query, by the server, to determine a similar case cluster further comprises matching the prediction query to a health feature of an associated feature cluster selected from the class prediction models of the similar case cluster stored in a target specific optimal associated feature database to determine a corresponding similar case cluster,
wherein the selected associated feature is an associated feature extracted during a process for selecting an associated feature class prediction model that satisfies a criterion for a predetermined accuracy among all associated features.

14. The method of claim 12, wherein searching for a class prediction model, by the server, for the determined similar case cluster comprises searching for a prediction model for a similar case cluster determined to be matched with the prediction query from a similar case prediction model database and loading the prediction model.

15. A future health trend prediction method through a similar case cluster-based prediction model, the method comprising:
calculating an accuracy, by a server, for a corresponding prediction model of an associated feature cluster matched with a prediction query of health information of a user received from a user terminal and filtering a prediction model satisfying a predetermined accuracy;
calculating a plurality of class prediction results, by the server, for the plurality of filtered prediction models; and
performing an ensemble of the plurality of class prediction results, by the server, to output the combined class prediction result to the user terminal.
